(19) United States
(12) Patent Application Publication
(10) Pub. No.: US 2006/0126675 A1
(43) Pub. Date: Jun. 15, 2006

(54) Solid-state laser device

(75) Inventors: Taizo Eno, Itabashi-ku (JP); Masayuki Momiuchi, Itabashi-ku (JP); Yoshiaki Goto, Itabashi-ku (JP)

Correspondence Address: NIELDS & LEMACK, 176 EAST MAIN STREET, SUITE 7, WESTBORO, MA, 01581, US

(73) Assignee: Kabushiki Kaisha TOCON

(21) Appl. No.: 11/294,184

(22) Filed: Dec. 5, 2005

(30) Foreign Application Priority Data
Dec. 14, 2004 (JP) 2004-360734
Sep. 15, 2005 (JP) 2005-268846

(51) Int. Cl. H01S 3/10

(52) U.S. Cl. 372/21

(57) ABSTRACT

A solid-state laser device, comprising a first optical axis and a second optical axis having a commonly used optical axis portion and separated by an optical axis separating means, a first resonator composed on the first optical axis, a second resonator composed on the second optical axis, a first light emitter for allowing an excitation light to enter the first resonator, a second light emitter for allowing an excitation light to enter the second resonator, a wavelength conversion unit provided on the commonly used optical axis portion, and an output mirror provided on an exit side of the wavelength conversion unit, wherein the wavelength conversion unit comprises two or more optical crystals for wavelength conversion, the output mirror has two or more individual output mirrors, and a wavelength of a laser beam to be projected is determined by selection of turning-on or turning-off of the first light emitter and the second light emitter, and also by selection of the optical crystals for wavelength conversion and the individual output mirrors depending on turning-on and turning-off of the first light emitter and the second light emitter.

### BACKGROUND OF THE INVENTION

The present invention relates to a solid-state laser device, by which laser beams with a plurality of wavelengths can be projected.

In recent years, laser beams have been widely used in fields of medical treatment. For example, a laser operation system for medical treatment is known, by which laser beams are projected to an affected site or sites of a patient.

Medical instruments and systems using laser beams are used for the purposes such as photocoagulation, resection, incision, etc. of the site or sites to be treated on non-contact basis. Color, i.e. wavelength, of a laser beam used differs according to the type of medical treatment. In a laser device used as a laser light source of the medical instrument or system, it is desirable to supply laser beams with a plurality of wavelengths to the medical instrument or system.

As a laser light source, it is now wanted to replace the conventional type Kr laser or dye laser to a diode-pumped solid-state laser, which is compact in design and is maintenance-free.

A conventional type solid-state laser device, which uses an LD (laser diode) as an excitation light source and which can project laser beams with a plurality of wavelengths is disclosed in JP-A-2002-151774.

Now, description will be given referring to FIG. 15.

In FIG. 15, reference numeral 1 denotes a laser oscillator, 2 denotes a control unit, and 3 denotes an operation unit. The control unit 2 controls change of a wavelength of a laser beam emitted from the laser oscillator 1 and controls intensity, etc. of the laser beam. The operation unit 3 is provided with switches to select the wavelength and with various types of switches for setting and inputting projecting conditions of the laser beams.

The laser oscillator 1 comprises a semiconductor laser 4, which is an excitation light source. A laser beam emitted from the semiconductor laser 4 is guided to a first resonator 5, a second resonator 6, and a third resonator 7.

The first resonator 5 comprises a first reflection mirror 9, a laser crystal 11 and an output mirror 12 which is a semitransparent mirror, which are arranged on a first optical axis 8a, and a first optical member (nonlinear crystal) 14a for wavelength conversion and a second reflection mirror 15a which are provided on a reflection light optical axis 13 of the output mirror 12.

The second resonator 6 has a second optical axis 8b. On the second optical axis 8b, there are provided a reflection mirror 16 for the second resonator movably arranged on the second optical axis 8b, a second optical member (nonlinear crystal) 14b for wavelength conversion and a third reflection mirror 15b which are provided on the second optical axis 8b. The reflection mirror 16 for the second resonator is moved by a driving unit 17 for the second resonator, and the reflection mirror 16 for the second resonator is positioned at an intersection of the reflection light optical axis 13 with the second optical axis 8b.

The third resonator 7 has a third optical axis 8c. On the third optical axis 8c, there are provided a reflection mirror 18 for the third resonator movably arranged on the third optical axis 8c, a third optical member (nonlinear crystal) 14c for wavelength conversion and a fourth reflection mirror 15c which are arranged on the third optical axis 8c. The reflection mirror 18 for the third resonator is moved by a driving unit 19 for the third resonator, and the reflection mirror 18 for the third resonator is positioned at an intersection of the reflection light optical axis 13 with the third optical axis 8c.

When a laser beam with a first wavelength is projected in the laser device as described above, the reflection mirror 16 for the second resonator and the reflection mirror 18 for the third resonator are moved backward from the reflection light optical axis 13. Upon entering the first resonator 5, the laser beam is amplified between the first reflection mirror 9 and the second reflection mirror 15a, and the laser beam passes through the output mirror 12 and is projected.

When a laser beam with a second wavelength is projected, the reflection mirror 16 for the second resonator is moved to an intersection of the reflection light optical axis 13 with the second optical axis 8b. The laser beam is amplified by the second resonator 6, which comprises the components between the first reflection mirror 9 and the third reflection mirror 15b. Then, the laser beam passes through the output mirror 12 and is projected.

When a laser beam with a third wavelength is projected, the reflection mirror 16 for the second resonator is moved backward from the reflection light optical axis 13. The reflection mirror 18 for the third resonator is moved to an intersection of the reflection light optical axis 13 with the third optical axis 8c. The laser beam is amplified by the third resonator 7, which comprises the components between the first reflection mirror 9 and the fourth reflection mirror 15c. Then, the laser beam passes through the output mirror 12 and is projected.

By selecting positions of the reflection mirror 16 for the second resonator and the reflection mirror 18 for the third resonator, laser beams with a plurality of wavelengths can be projected.

The conventional type laser device as described above requires the optical axes 8a, 8b and 8c for each of the wavelengths of the projected laser beams, the reflection mirror 16 for the second resonator and the reflection mirror 18 for the third resonator arranged individually on the optical axes 8b and 8c, guiding mechanisms for individually guiding the reflection mirror 16 for the second resonator and the reflection mirror 18 for the third resonator, and further, the driving unit 17 for the second resonator and the driving unit 19 for the third resonator driven individually, and so on. Thus, a number of components are required and the mechanism of the device is very complicated. Also, for adjustment of the reflection mirror 16 for the second resonator and the reflection mirror 18 for the third resonator, an inserting position and an angle must be adjusted, and adjusting procedure is complicated.

Further, in case it is wanted to increase the types of wavelengths of the projected laser beams, a reflection mirror for the resonator, a guiding mechanism for the reflection mirror, and a driving unit for the resonator are required individually for each wavelength. This means that more complicated structure is required and the system of larger scale is needed, and this leads to such problem that the manufacturing cost is increased.

### SUMMARY OF THE INVENTION

It is an object of the present invention to provide a solid-state laser device, which is designed in simple construction and by which it is possible to project laser beams with two or more wavelengths.

To attain the above object, the present invention provides a solid-state laser device, which comprises a first optical axis and a second optical axis having a commonly used optical axis portion and separated by an optical-axis separating means, a first resonator composed on the first optical axis, a second resonator composed on the second optical axis, a first light emitter for allowing an excitation light to enter the first resonator, a second light emitter for allowing an excitation light to enter the second resonator, a wavelength conversion unit provided on the commonly used optical axis portion, and an output mirror provided on an exit side of the wavelength conversion unit, wherein the wavelength conversion unit comprises two or more optical crystals for wavelength conversion, the output mirror has two or more individual output mirrors, and a wavelength of a laser beam to be projected is determined by selection of turning-on or turning-off of the first light emitter and the second light emitter, and also by selection of the optical crystals for wavelength conversion and the individual output mirrors depending on turning-on and turning-off of the first light emitter and the second light emitter. Also, the present invention provides the solid-state laser device as described above, wherein the two or more optical crystals for wavelength conversion are selectively positioned on said commonly used optical axis portion by a wavelength switching means, and said two or more individual output mirrors are selectively positioned on said commonly used optical axis portion by an output mirror switching means. Further, the present invention provides the solid-state laser device as described above, wherein the two or more individual output mirrors and said plurality of optical crystals for wavelength conversion to match types of the projected laser beams are integrally provided, wherein the two or more optical crystals for wavelength conversion are provided integrally with corresponding individual output mirrors, and the individual output mirrors and said optical crystals for wavelength conversion are selectively positioned on the commonly used optical axis portion by a wavelength switching means. Also, the present invention provides the solid-state laser device as described above, wherein said wavelength switching means selectively positions said optical crystals for wavelength conversion by sliding from a direction crossing with respect to the commonly used optical axis portion. Further, the present invention provides the solid-state laser device as described above, wherein said output mirror switching means selectively positions said individual output mirrors provided on a rotating disk by rotating said rotating disk. Also, the present invention provides the solid-state laser device as described above, wherein said wavelength switching means selectively positions said individual output mirror and said optical crystals for wavelength conversion by sliding from a direction crossing with respect to said commonly used optical axis. Further, the present invention provides the solid-state laser device as described above, wherein said output mirror switching means selectively positions said optical crystals for wavelength conversion and said individual output mirrors provided on a the rotating disk by rotating said rotating disk. Also, the present invention provides the solid-state laser device as described above, wherein a Q-SW element is provided on said commonly used optical axis portion. Further, the present invention provides the solid-state laser device as described above, wherein a Q-SW element is integrally provided to match at least one of said individual output mirrors. Also, the present invention provides the solid-state laser device as described above, wherein a Q-SW element is provided on at least one of said first optical axis and said second optical axis being separated. Further, the present invention provides the solid-state laser device as described above, wherein individual intermediate mirrors being highly reflective to a conversion wavelength are integrally provided on each of incident sides of the optical crystals for wavelength conversion. Also, the present invention provides the solid-state laser device as described above, wherein said first resonator comprises a first solid-state laser medium, said second resonator comprises a second solid-state laser medium, wherein a direction of a crystal axis of said first solid-state laser medium and a direction of a crystal axis of said second solid-state laser medium are adjusted in such manner that oscillated fundamental waves are linearly polarized lights and have different directions of polarization.

According to the present invention, a solid-state laser device comprises a first optical axis and a second optical axis having a commonly used optical axis portion and separated by an optical axis separating means, a first resonator arranged on the first optical axis, a second resonator arranged on the second optical axis, a first light emitter for allowing an excitation light to enter the first resonator, a second light emitter for allowing an excitation light to enter the second resonator, a wavelength conversion unit provided on the commonly used optical axis portion, and an output mirror provided on an exit side of the wavelength conversion unit, wherein the wavelength conversion unit comprises two or more optical crystals for wavelength conversion, the output mirror has two or more individual output mirrors, and a wavelength of a laser beam to be projected is determined by selection of turning-on or turning-off of the first light emitter and the second light emitter, and also by selection of the optical crystals for wavelength conversion and the individual output mirrors depending on turning-on and turning-off of the first light emitter and the second light emitter. As a result, a wide variety of laser beams can be projected by a device with simple construction.

Also, according to the present invention, in the solid-state laser device as described above, said two or more individual output mirrors and said two or more optical crystals for wavelength conversion to match types of the projected laser beams are integrally provided with corresponding individual output mirrors, and said individual output mirrors and said optical crystals for wavelength conversion are selectively positioned on the commonly used optical axis portion by a wavelength switching means. Thus, the relation between the individual output mirror and the optical crystal for wavelength conversion is not affected due to the switchover of the wavelength and the aspect of the laser beam, and switching can be achieved with high accuracy.

Further, according to the present invention, in the solid-state laser device described above, said wavelength switching means selectively positions said optical crystals for wavelength conversion by sliding from a direction crossing with respect to the commonly used optical axis portion. Thus, there is no influence on optical axis of resonation, and switching can be achieved with high accuracy.

Also, according to the present invention, in the solid-state laser device described above, said output mirror switching means selectively positions said individual output mirrors provided on a rotating disk by rotating said rotating disk. Because positioning is performed by a rotating mechanism, high accuracy is assured, and the mechanism can be produced in simple design.

Further, according to the present invention, in the solid-state laser device described above, said output mirror switching means selectively positions said optical crystals for wavelength conversion and said individual output mirrors provided on a rotating disk by rotating said rotating disk. Because positioning is performed by a rotating mechanism, high accuracy is assured, and the mechanism can be produced in simple design.

Also, according to the present invention, in the solid-state laser device described above, a Q-SW element is provided on said commonly used optical axis portion. Thus, it is possible to project pulsed laser beams with two or more different wavelengths.

Further, according to the present invention, in the solid-state laser device described above, a Q-SW element is provided on at least one of said first optical axis and said second optical axis being separated. The Q-SW element should match only one of the laser beams, and this contributes to simple construction and easier adjustment of optical axes, etc.

Also, according to the present invention, in the solid-state laser device described above, individual intermediate mirrors being highly reflective to a conversion wavelength are integrally provided on each of incident sides of the optical crystals for wavelength conversion. As a result, the device can be produced with simple construction and in compact design.

### BRIEF DESCRIPTION OF THE DRAWINGS

FIG. 1 is a schematical block diagram of a basic optical system according to the present invention;

FIG. 2 (A) is a drawing to show a basic arrangement of a first embodiment of the present invention, and FIG. 2 (B) is a perspective view of a rotating disk;

FIG. 3 is a drawing to explain operation of the first embodiment of the present invention;

FIG. 4 is a drawing to explain operation of the first embodiment of the present invention;

FIG. 5 is a drawing to explain operation of the first embodiment of the present invention;

FIG. 6 is a drawing to show a basic arrangement of a second embodiment of the present invention;

FIG. 7 is a drawing to explain operation of the second embodiment of the present invention;

FIG. 8 are drawings to explain a third embodiment of the present invention. FIG. 8 (A) shows projection of a pulsed laser beam with converted wavelength, and FIG. 8 (B) shows projection of a pulsed laser beam with fundamental wave.

FIG. 9 is a drawing to show a basic arrangement of a fourth embodiment of the present invention;

FIG. 10 is a drawing to explain operation of the fourth embodiment of the present invention;

FIG. 11 is a drawing to explain operation of the fourth embodiment of the present invention;

FIG. 12 is a drawing to explain operation of the fourth embodiment of the present invention;

FIG. 13 is a drawing to explain operation of the fourth embodiment of the present invention;

FIG. 14 is a drawing to explain operation of the fourth embodiment of the present invention; and

FIG. 15 is a drawing to explain a conventional type solid-laser device.

### DETAILED DESCRIPTION OF THE PREFERRED EMBODIMENTS

Description will be given below on the best mode to carry out the present invention referring to the drawings.

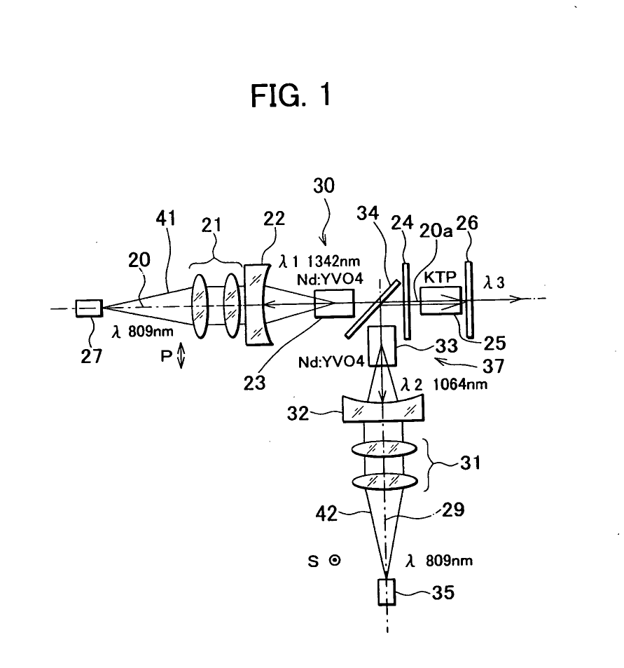

First, brief description will be given on a basic optical system of a solid-state laser device according to the present invention referring to FIG. 1.

On a first optical axis 20, there are arranged a first condenser lens unit 21, a first concave mirror 22, a first solid-state laser medium (a first laser crystal) 23, an intermediate mirror 24, a wavelength conversion unit (NLO) 25 comprising a nonlinear optical medium, and an output mirror 26. An LD light emitter 27 is arranged at a position opposite to the first condenser lens unit 21. A laser beam 41 emitted from the LD light emitter 27 enters the first condenser lens unit 21.

Between the first solid-state laser medium 23 and the intermediate mirror 24 and along a second optical axis 29, which crosses the first optical axis 20, e.g. at 90°, there are provided a second condenser lens unit 31, a second concave mirror 32, and a second solid-state laser medium (a second laser crystal) 33. A polarization beam splitter 34 is provided at a position where the first optical axis 20 and the second optical axis 29 cross each other. The second optical axis 29 is bent by the polarization beam splitter 34, and a portion between the polarization beam splitter 34 and the output mirror 26 is commonly used by the first optical axis 20 and the second optical axis 29.

The wavelength conversion unit 25 is positioned at a commonly used portion 20a of the first optical axis 20 and the second optical axis 29. The wavelength conversion unit 25 comprises an optical crystal for wavelength conversion. The optical crystal for wavelength conversion converts an incident laser beam to a second harmonic wave, or the optical crystal for wavelength conversion converts two incident laser beams to sum frequency (or difference frequency). The polarization beam splitter 34 fulfills a function as an optical axis separating means to separate the first optical axis 20 and the second optical axis 29 from each other.

An LD light emitter 35 is arranged at a position opposite to the second condenser lens unit 31. A laser beam 42 emitted from the LD light emitter 35 enters the second condenser lens unit 31.

A first resonator 30 with wavelength λ1 of a first fundamental wave is composed between the first concave mirror 22 and the output mirror 26. A second resonator 37 with wavelength λ2 of a second fundamental wave is composed between the second concave mirror 32 and the output mirror 26.

In each of the first solid-state laser medium 23 and the second solid-state laser medium 33, a direction of a crystal axis is adjusted in such manner that the first fundamental wave oscillated and the second fundamental wave oscillated are both linearly polarized lights and have different directions of polarization. For example, a P-polarized light is oscillated at the first solid-state laser medium 23, and an S-polarized light is oscillated at the second solid-state laser medium 33. The polarization beam splitter 34 allows the P-polarized light to pass and reflects the S-polarized light.

The first concave mirror 22 is highly transmissive to an excitation light with wavelength λ, and the first concave mirror 22 is highly reflective to the first fundamental wave with wavelength of λ1. The second concave mirror 32 is highly transmissive to the excitation light with wavelength λ, and the second concave mirror 32 is highly reflective to the second fundamental wave with [0038]

The intermediate mirror 24 is highly transmissive to the first fundamental wave with wavelength of λ1 and to the second fundamental wave with wavelength of λ2, and the intermediate mirror 24 is highly reflective to a wavelength conversion light with wavelength of λ3 [sum frequency (SFM) or difference frequency (DFM) or SHG1 (λ1/2), or SHG2 (λ2/2)]. The output mirror 26 is highly reflective to the first fundamental wave with wavelength of λ1 and the second fundamental wave with wavelength of λ2. The output mirror 26 is highly transmissive to the wavelength conversion light with wavelength of λ3 [sum frequency (SFM) or difference frequency (DFM) or SHG1 (λ1/2), SHG2 (λ2/2)].

In the arrangement as described above, the laser beams 41 and 42 projected from the LD light emitter 27 and the LD light emitter 35 have an excitation light with wavelength of λ=809 nm. As the first solid-state laser medium 23 and the second solid-state laser medium 33, Nd:YVO₄ having oscillation lines of 1342 nm and 1064 nm are used respectively.

As the laser crystal, YAG (yttrium aluminum garnet) doped with Nd³⁺ ions and the like are adopted in addition to Nd:YVO₄. YAG has oscillation lines of 946 nm, 1342 nm, 1319 nm, etc. Ti (sapphire) and the like with oscillation lines of 700 nm to 900 nm may be used.

As an optical crystal for wavelength conversion to be used in the wavelength conversion unit 25, KTP (KTiOPO₄; titanyl potassium phosphate) is used. In the optical crystal for wavelength conversion, an angle of a crystal axis with respect to the optical axis is adjusted for sum frequency (SFM) (or difference frequency DFM), SHG1 (λ1/2), or SHG2 (λ2/2) to match the wavelength of the laser beam as required.

In addition to KTP, BBO (β-BaB₂O₄; β-barium borate), LBO (LiB₃O₅; lithium triborate), KNbO₃ (potassium niobate), etc. are used as the optical crystal for wavelength conversion. Or, periodically poled inversion element (periodically poled lithium niobate (PPLN)) may be used.

In the arrangement of the solid-state laser device as described above, the first resonator 30 and the second resonator 37 are separate from each other except the intermediate mirror 24, the wavelength conversion unit 25 and the output mirror 26. The laser beam 41 entering the first resonator 30 from the LD light emitter 27 forms a light converging point between the first concave mirror 22 and the polarization beam splitter 34 in the figure, and this light converging point is positioned within or near the first solid-state laser medium 23. Similarly, the laser beam 42 entering the second resonator 37 from the LD light emitter 35 forms a light converging point between the second concave mirror 32 and the polarization beam splitter 34 in the figure, and this light converging point is positioned within or near the second solid-state laser medium 33.

Excitation efficiencies of the first solid-state laser medium 23 and the second solid-state laser medium 33 are influenced by energy density of the laser beam or by the direction of polarization. Because positions of the first solid-state laser medium 23 and the second solid-state laser medium 33 can be adjusted individually, the first solid-state laser medium 23 and the second solid-state laser medium 33 can be set at optimal positions respectively. Also, the direction of polarization can be adjusted individually for the LD light emitter 27 and the LD light emitter 35, and the adjustment can be made much easier. In the adjustment of the positions of the optical members, e.g. optical axis matching of the first concave mirror 22 and the second concave mirror 32, the adjustment of one of the concave mirrors does not exert influence on the adjustment of the other. Thus, after one of them has been adjusted, the other can be adjusted, and the adjustment can be easily carried out. Further, polarized lights of two excitation light components can be made in parallel to each other or cross each other perpendicularly. As a result, there is no restriction on the optical crystal for wavelength conversion, and any type of optical crystal for wavelength conversion can be used.

The commonly used portion of the second optical axis 29 deflected by the polarization beam splitter 34 can be completely or almost completely aligned with the first optical axis 20. Complete or almost complete alignment of the optical axes contributes to the improvement of conversion efficiency of the wavelength conversion unit 25.

The laser beam 41 from the LD light emitter 27 enters the first solid-state laser medium 23, and the laser beam 42 from the LD light emitter 35 enters the second solid-state laser medium 33 both individually. This means that less load is applied on the first solid-state laser medium 23 and the second solid-state laser medium 33. Because a wavelength conversion light can be obtained by the laser beams 41 and 42 from two sets of the LD light emitters 27 and 35 respectively, high output can be achieved.

The optical crystal for wavelength conversion of the wavelength conversion unit 25 is set for SFM (or for DFM) in the arrangement as described above. When the excitation lights with wavelength λ from the LD light emitters 27 and 35 are entered at the same time, a laser beam of SFM (or DFM) is projected from the output mirror 26.

Also, the optical crystal for wavelength conversion is set for SHG1 (λ1/2) and the LD light emitter 27 is turned on while the LD light emitter 35 is turned off. When only the excitation light from the LD light emitter 27 enters, a laser beam of SHG1 is projected from the output mirror 26.

Further, the optical crystal for wavelength conversion is set for SHG2 (λ2/2) and the LD light emitter 35 is turned on while the LD light emitter 27 is turned off. When only the excitation light from the LD light emitter 35 enters, a laser beam of SHG2 is projected from the output mirror 26.

As described above, the setting condition of the optical crystal for wavelength conversion of the wavelength conversion unit 25 is changed in the above optical system and the on-off conditions of the LD light emitters 27 and 35 are selected. As a result, laser beams with a plurality of wavelengths can be projected without changing the basic optical arrangement.

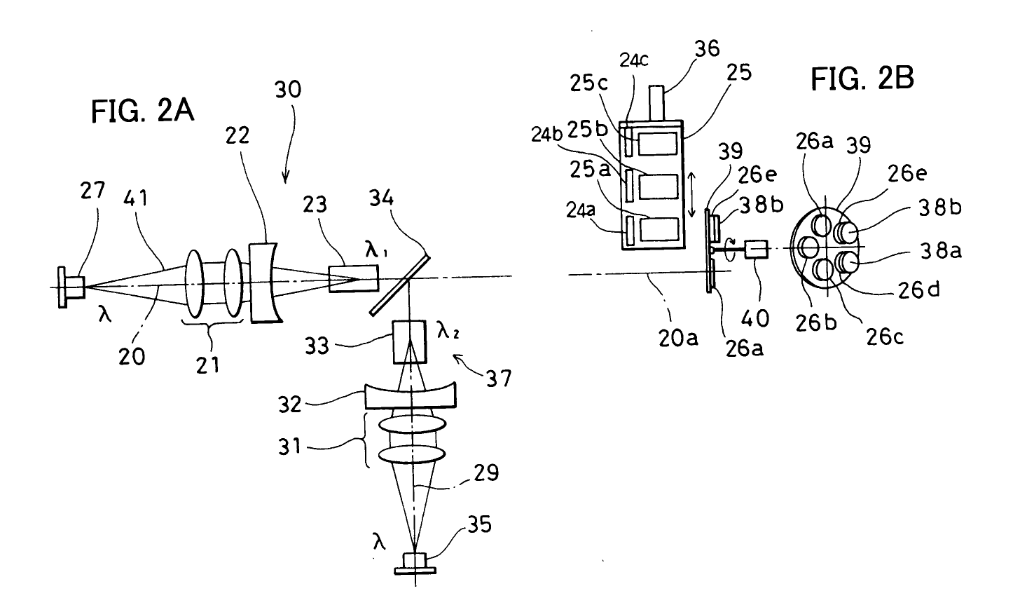

Next, description will be given on a first embodiment of the invention having the basic optical system as given above by referring to FIG. 2 to FIG. 5.

FIG. 2 shows basic arrangement of the first embodiment. In FIG. 2, the same component as shown in FIG. 1 is referred by the same symbol, and detailed description is not given here.

The wavelength conversion unit 25 is supported by a wavelength converting means 36. The wavelength converting means 36 can move the wavelength conversion unit 25 in a direction perpendicular to the commonly used optical axis portion 20a. Optical crystals 25a, 25b and 25c for wavelength conversion can be individually positioned on the commonly used optical axis portion 20a. When the optical crystal 25a for wavelength conversion is positioned on the commonly used optical axis portion 20a while the first fundamental wave and the second fundamental wave are oscillated, the sum frequency SFM is oscillated. When the optical crystal 25b for wavelength conversion is positioned on the commonly used optical axis portion 20a while only the first fundamental wave (λ1) is oscillated, the first of the second harmonic wave SHG1 (λ1/2) is oscillated. When the optical crystal 25c for wavelength conversion is positioned on the commonly used optical axis portion 20a while only the second fundamental wave (λ2) is oscillated, the second of the second harmonic wave SHG2 (λ2/2) is oscillated.

Individual intermediate mirrors 24a, 24b and 24c are provided to match the optical crystals 25a, 25b and 25c for wavelength conversion respectively, and it is arranged in such manner that the individual intermediate mirrors 24a, 24b and 24c are moved integrally with the optical crystals 25a, 25b and 25c for wavelength conversion.

The individual intermediate mirror 24a is highly transmissive to the excitation light (λ), to the first fundamental wave (λ1), and to the second fundamental wave (λ2), and the individual intermediate mirror 24a is highly reflective to the wavelength λ3 [sum frequency (SFM) or difference frequency (DFM)] of a wavelength conversion light oscillated when the first fundamental wave (wavelength λ1) and the second fundamental wave (wavelength λ2) enter the optical crystal 25a for wavelength conversion. The individual intermediate mirror 24b is highly transmissive to the excitation light (λ), to the first fundamental wave (λ1/1), and to the second fundamental wave (λ2), and the individual intermediate mirror 24b is highly reflective to a wavelength λ3 (SHG1) of the wavelength conversion light of the first fundamental wave (wavelength λ1) oscillated by the optical crystal 25b for wavelength conversion. The individual intermediate mirror 24c is highly transmissive to the excitation light (wavelength λ), to the first fundamental wave (wavelength λ1), and to the second fundamental wave (wavelength λ2), and the individual intermediate mirror 24c is highly reflective to a wavelength λ3 (SHG2) of a conversion light of the second fundamental wave (wavelength λ2) oscillated by the optical system 25c for wavelength conversion.

The output mirror 26 comprises a plurality of individual output mirrors 26a, 26b, 26c, 26d and 26e (5 mirrors in the figure). Among these individual output mirrors 26a, 26b, 26c, 26d and 26e, for the individual output mirrors 26d and 26e, Q-SW elements 38a and 38b are integrally provided on an exit side of the individual output mirrors 26d and 26e respectively. The individual output mirrors 26a, 26b, 26c, 26d and 26e as well as the Q-SW elements 38a and 38b are provided on a rotating disk 39. The rotating disk 39 is rotated by an output mirror switching means 40 so that each of the individual output mirrors 26a, 26b, 26c, 26d and 26e is positioned on the commonly used optical axis portion 20a.

The individual output mirror 26a is highly reflective to the excitation light (wavelength λ), to the first fundamental wave (wavelength λ1), and to the second fundamental wave (wavelength λ2), and the individual output mirror 26a is highly transmissive to the wavelength λ3 of the wavelength conversion light [sum frequency (SFM) or difference frequency (DFM), or SHG1 (λ1/2), or SHG2 (λ2/2)]. The individual output mirror 26b is highly reflective to the wavelength λ of the excitation light, and the individual output mirror 26b is highly transmissive to the wavelength λ1 of the first fundamental wave. The individual output mirror 26c is highly reflective to the wavelength λ of the excitation light and the individual output mirror 26c is highly transmissive to the wavelength λ2 of the second fundamental wave. The individual output mirror 26d is highly reflective to the wavelength λ of the excitation light and the individual output mirror 26d is highly transmissive to the wavelength λ1 of the first fundamental wave. The individual output mirror 26e is highly reflective to the wavelength λ of the excitation light and the individual output mirror 26e is highly transmissive to the wavelength λ2 of the second fundamental wave.

As the Q-SW elements 38a and 38b, EO (electro-optic), A0 (acousto-optic) (oversaturated absorptive material), e.g. Cr:YAG, is used. By the Q-SW elements 38a and 38b, an incident continuous laser beam is pulse-oscillated to a high-output pulsed laser beam.

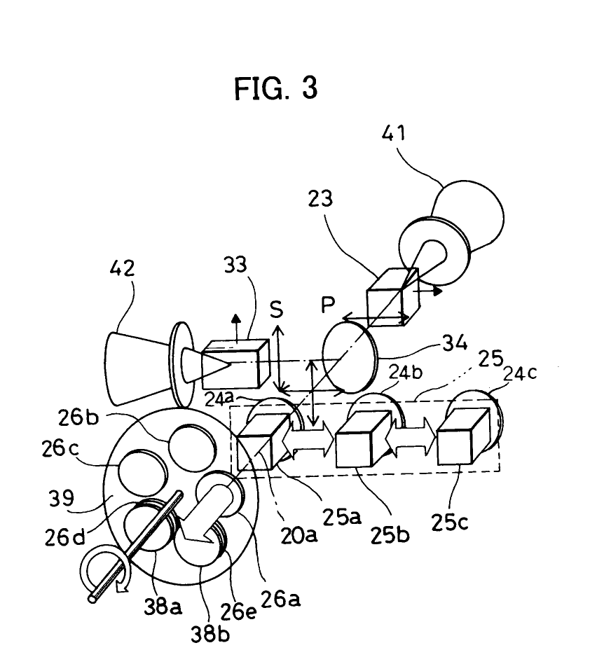

Now, description will be given on operation of the first embodiment referring to FIG. 3 to FIG. 5.

FIG. 3 shows a case where the individual intermediate mirror 24a and the optical crystal 25a for wavelength conversion are positioned on the commonly used optical axis portion 20a by the wavelength switching means 36, and the individual output mirror 26a is positioned on the commonly used optical axis portion 20a by the output mirror switching means 40.

When the LD light emitters 27 and 35 are turned on at the same time and the laser beams 41 and 42 with the wavelength λ (e.g. 809 nm) of the excitation light enter, the wavelength λ1 (1342 nm) of the first fundamental wave is oscillated by the first resonator 30. The wavelength λ2 (1064 nm) of the second fundamental wave is oscillated by the second resonator 37. Further, when the first fundamental wave (wavelength λ1) and the second fundamental wave (wavelength λ2) enter the optical crystal 25a for wavelength conversion, SFM (wavelength 593 nm) is oscillated, and SFM is projected from the individual output mirror 26a.

Next, while maintaining the conditions of the individual output mirror 26a, the individual intermediate mirror 24b and the optical crystal 25b for wavelength conversion are positioned on the commonly used optical axis portion 20a. The LD light emitter 27 is turned on while the LD light emitter 35 is turned off, and only the laser beam 41 is allowed to enter the first resonator 30. The fundamental wave with wavelength λ1 (wavelength 1342 nm) is oscillated by the first resonator 30. SHG1 (wavelength 671 nm) is oscillated by the optical crystal 25b for wavelength conversion, and SHG1 is projected from the individual output mirror 26a.

While maintaining the conditions of the individual output mirror 26a, the individual intermediate mirror 24c and the optical crystal 25c for wavelength conversion are positioned on the commonly used optical axis portion 20a. The LD light emitter 35 is turned on while the LD light emitter 27 is turned off, and only the laser beam 42 is allowed to enter the second resonator 37. The second fundamental wave with wavelength λ2 (wavelength 1064 nm) is oscillated by the second resonator 37. SHG2 (wavelength 532 nm) is oscillated by the optical crystal 25c for wavelength conversion, and SHG2 is projected from the individual output mirror 26a.

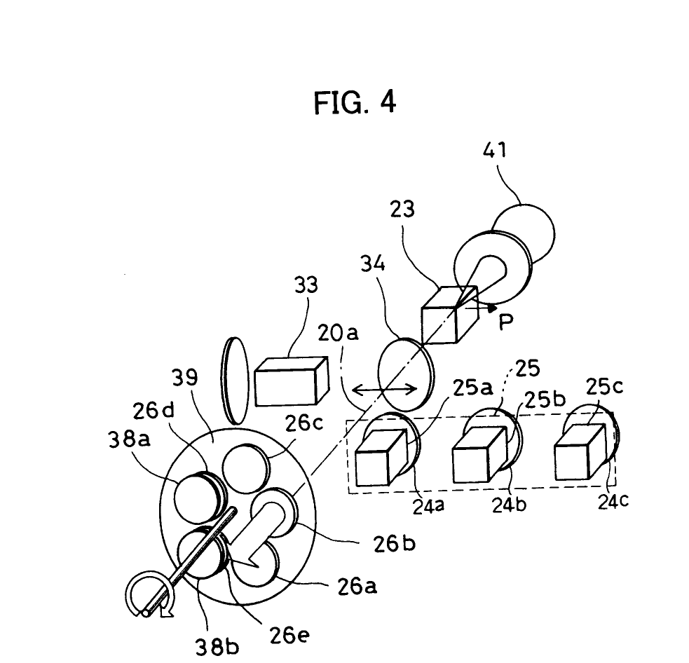

The wavelength conversion unit 25 is removed from the commonly used optical axis portion 20a by the wavelength switching means 36, and the individual output mirror 26b is positioned on the commonly used optical axis portion 20a by the output mirror switching means 40. The LD light emitter 27 is turned on while the LD light emitter 35 is turned off, and only the laser beam 41 is allowed to enter the first resonator 30. The first fundamental wave with wavelength λ1 (1342 nm) is oscillated by the first resonator 30, and the first fundamental wave with wavelength λ1 is projected from the individual output mirror 26b (see FIG. 4).

The individual output mirror 26c is positioned on the commonly used optical axis portion 20a by the output mirror switching means 40. The LD light emitter 35 is turned on while the LD light emitter 27 is turned off, and only the laser beam 42 is allowed to enter the second resonator 37. The second fundamental wave with wavelength λ2 (1064 nm) is oscillated by the second resonator 37, and the second fundamental wave with wavelength λ2 is projected from the individual output mirror 26c.

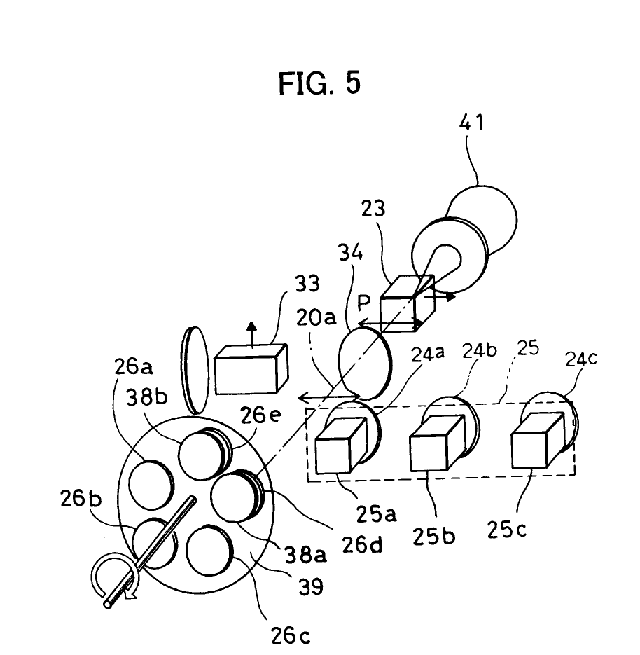

Under the condition that the wavelength conversion unit 25 is separated from the commonly used optical axis portion 20a, the rotating disk 39 is rotated by the output mirror switching means 40, and the individual output mirror 26d and the Q-SW element 38a are positioned on the commonly used optical axis portion 20a. The LD light emitter 27 is turned on while the LD light emitter 35 is turned off, and only the laser beam 41 is allowed to enter the first resonator 30. The fundamental wave with wavelength of λ1 (1342 nm) is oscillated by the first resonator 30. The first fundamental wave with wavelength λ1 is projected from the individual output mirror 26d. Further, pulse-oscillation is performed by the Q-SW element 38a, and a pulsed laser beam of the first fundamental wave with wavelength λ1 is projected (see FIG. 5).

Similarly, under the condition that the wavelength conversion unit 25 is separated from the commonly used optical axis portion 20a, the rotating disk 39 is rotated by the output mirror switching means 40, and the individual output mirror 26e and the Q-SW element 38b are positioned on the commonly used optical axis portion 20a. The LD light emitter 35 is turned on while the LD light emitter 27 is turned off, and only the laser beam 42 is allowed to enter the second resonator 37. The second fundamental wave with wavelength λ2 (1064 nm) is oscillated by the second resonator 37. The second fundamental wave with wavelength λ2 is projected from the individual output mirror 26e. Further, pulse-oscillation is performed by the Q-SW element 38b, and a pulsed laser beam with wavelength λ2 of the second fundamental wave is projected.

It may be designed in such manner that the individual output mirror 26b and the individual output mirror 26c as well as the individual output mirror 26d and the individual output mirror 26e are highly reflective to the wavelength λ of the excitation light, and that these are highly transmissive to the first fundamental wave (wavelength λ1) and the second fundamental wave (wavelength λ2). In such case, either one of the individual output mirror 26b or the individual output mirror 26c may not be used. Also, either one of the set of the individual output mirror 26d and Q-SW element 38a or the set of the individual output mirror 26e and the Q-SW element 38b may not be used.

The Q-SW elements 38a and 38b may be disposed on insident sides of the individual output mirrors 26d and 26e that is closer faces to the polarization beam splitter 34. Or, the Q-SW element 38 may be arranged on the output mirror 26a.

For the purpose of improving the projection efficiency of the first fundamental wave with wavelength λ1 and the second fundamental wave with wavelength λ2, the intermediate mirror 24a may be provided integrally with the optical crystal 25a for wavelength conversion on an end surface of the optical crystal 25a for wavelength conversion closer to the polarization beam splitter 34. Or, a dielectric reflection film equivalent to the intermediate mirror 24a may be provided on an end surface of the optical crystal 25a for wavelength conversion closer to the polarization beam splitter 34, i.e. a dielectric reflection film may be formed, which is highly transmissive to the wavelength λ of the excitation light, to the wavelength λ1 of the first fundamental wave, and to the wavelength λ2 of the second fundamental wave, and which is highly reflective to SFM (wavelength 593 nm), SHG1, and SHG2. By integrally designing the intermediate mirror 24, the reflection of the wavelength λ1 of the first fundamental wave and the reflection of the wavelength λ2 of the second fundamental wave by the intermediate mirror 24 can be eliminated, and this ontributes to the improvement of projection efficiency of the wavelength λ1 of the first fundamental wave and the wavelength λ2 of the second fundamental wave.

Similarly, the other intermediate reflection mirrors 24b and 24c may be integrated with the optical crystals 25b and 25c for wavelength conversion.

In this respect, laser beams with 5 different wavelengths and 7 different aspects can be projected in the first embodiment.

Although not specifically shown in the figure, a control unit controls lighting condition of the LD light emitters 27 and 35, selection of the optical crystals 25a, 25b and 25c for wavelength conversion by the wavelength switching means 36, and selection of the output mirrors 26a, 26b, 26c, 26d and 26e by the output mirror switching means 40. By inputting the selection of wavelength and the selection of the aspect from an operation unit (not shown), the turning-on of the LD light emitters 27 and 35 and the wavelength switching means 36 and the output mirror switching means 40 are controlled by the control unit so that the laser beams with wavelength and aspect as desired are projected.

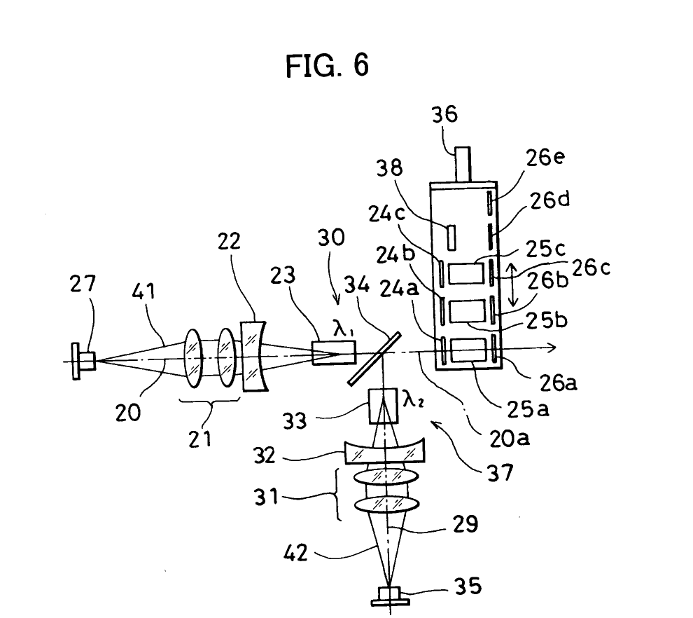

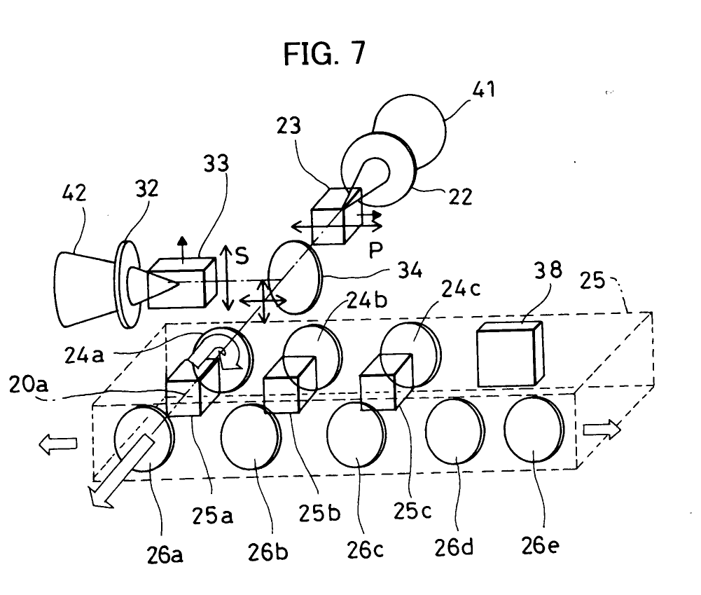

Referring to FIG. 6 and FIG. 7, description will be given below on a second embodiment of the invention.

In FIG. 6 and FIG. 7, the same component as shown in FIG. 2 to FIG. 5 is referred by the same symbol, and detailed description is not given here.

In the second embodiment, the output mirror 26 and the intermediate mirror 24 are incorporated in the wavelength conversion unit 25. It is designed in such manner that the optical crystal of the wavelength conversion unit 25 is switched over by the wavelength switching means 36, and that the output mirror 26 and the intermediate mirror 24 are switched over integrally with the optical crystals for wavelength conversion.

The wavelength conversion unit 25 comprises optical crystals 25a, 25b and 25c for wavelength conversion and also comprises individual output mirrors 26a, 26b, 26c, 26d and 26e to match the types of the projected laser beams. There are provided individual output mirrors 26a, 26b and 26c on exit sides of the laser beams to correspond to each of the optical crystals 25a, 25b, and 25c for wavelength conversion, and individual intermediate mirrors 24a, 24b and 24c are integrally arranged on incident sides. Also, there are provided the individual output mirrors 26d together with the Q-SW elements 38, and further there is provided the individual output mirror 26e in the wavelength conversion unit 25. Each of the optical axes of the individual output mirrors 26a, 26b, 26c, 26d and 26e runs in parallel to the commonly used optical axis portion 20a.

The individual intermediate mirror 24a is highly transmissive to the wavelength λ of the excitation light, the wavelength λ1 of the first fundamental wave and the wavelength λ2 of the second fundamental wave, and the individual intermediate mirror 24a is highly reflective to the wavelength λ3 of the wavelength conversion light (SFM or DFM). The individual output mirror 26a is highly reflective to the excitation light (λ), to the first fundamental wave (λ1), and to the second fundamental wave (λ2), while the individual out put mirror 26a is highly transmissive to wavelength λ3 of the wavelength conversion light (SFM or DFM).

The individual intermediate mirror 24b is highly transmissive to the wavelength λ of the excitation light and to wavelength λ1 of the first fundamental wave while the individual intermediate mirror 24b is highly reflective to the wavelength λ3 of the wavelength conversion light (SHG1 (λ1/2)). The individual output mirror 26b is highly reflective to the excitation light (wavelength λ) and to the first fundamental wave (wavelength λ1), while the individual output mirror 26b is highly transmissive to the wavelength conversion light (wavelength λ3) (SHG1 (λ1/2)).

The individual intermediate mirror 24c is highly transmissive to the excitation light (wavelength λ) and to the second fundamental wave (wavelength λ2), while the individual intermediate mirror 24c is highly reflective to the wavelength conversion light (wavelength λ3) (SHG2 (λ2/2)). The individual output mirror 26c is highly reflective to the excitation light (wavelength λ) and to the second fundamental wave (wavelength λ2), while the individual output mirror 26c is highly transmissive to the wavelength conversion light (wavelength λ3) (SHG2 (λ2/2)).

The individual output mirrors 26d and 26e are highly reflective to the excitation light (wavelength λ), while the individual output mirrors 26d and 26e are highly transmissive to the first fundamental wave (wavelength λ1), and to the second fundamental wave (wavelength λ2).

The individual intermediate mirrors 24a, 24b and 24c are highly transmissive to the excitation light (wavelength λ), to the first fundamental wave (wavelength λ1), and to the second fundamental wave (wavelength λ2), while the individual intermediate mirrors 24a, 24b and 24c are highly reflective to the wavelength conversion light (wavelength λ3) (SFM or DFM or SHG1 (λ1/2) or SHG2 (λ2/2)). The individual output mirrors 26a, 26b and 26c are highly reflective to the excitation light (wavelength λ), to the first fundamental wave (wavelength λ1), and to the second fundamental wave (wavelength λ2), while the individual output mirrors 26a, 26b and 26c are highly transmissive to the wavelength conversion light (wavelength λ3) (SFM or DFM or SHG1 (λ1/2) or SHG2 (λ2/2)). In this case, the components with the same performance characteristics may be used.

As the individual intermediate mirrors 24a, 24b and 24c, dielectric reflection films formed on end surfaces on incident sides of the optical crystals 25a, 25b and 25c for wavelength conversion may be used.

In FIG. 7, the optical crystal 25a for wavelength conversion, the individual intermediate mirror 24a and the individual output mirror 26a are positioned on the commonly used optical axis portion 20a by the wavelength switching means 36. When the LD light emitters 27 and 35 are turned on and the laser beams 41 and 42 are allowed to enter, the first fundamental wave (wavelength λ1) and the second fundamental wave (λ2) are oscillated. SFM is oscillated by the optical crystal 25a for wavelength conversion, and a laser beam of SFM is projected by the individual output mirror 26a.

The optical crystal 25b for wavelength conversion, the individual intermediate mirror 24b and the individual output mirror 26b are positioned on the commonly used optical axis portion 20a. When only the LD light emitter 27 is turned on and the laser beam 41 is allowed to enter, the first fundamental wave (wavelength λ1) is oscillated by the first resonator 30, and a laser beam converted to SHG1 by the optical crystal 25b for wavelength conversion is projected from the individual output mirror 26b.

The optical crystal 25c for wavelength conversion, the individual intermediate mirror 24c and the individual output mirror 26c are positioned on the commonly used optical axis portion 20a. When only the LD light emitter 35 is turned on and the laser beam 42 is allowed to enter, the first fundamental wave (wavelength λ2) is oscillated by the second resonator 37, and a laser beam converted to SHG2 by the optical crystal 25c for wavelength conversion is projected from the individual output mirror 26c.

The individual output mirror 26d and the Q-SW element 38 are positioned on the commonly used optical axis portion 20a. When the LD light emitter 27 is turned on, the first fundamental wave (wavelength λ1) is oscillated by the first resonator 30. Pulse oscillation is performed at the Q-SW element 38, and a pulsed laser beam with wavelength λ1 of the first fundamental wave is projected from the individual output mirror 26d. When the LD light emitter 35 is turned on, the second fundamental wave (wavelength λ2) is oscillated. Pulse oscillation is performed on the Q-SW element 38, and a pulsed laser beam with wavelength λ2 of the second fundamental wave is projected from the individual output mirror 26d.

Further, when the individual output mirror 26e is positioned on the commonly used optical axis portion 20a and the LD light emitter 27 is turned on, a continuous laser beam with wavelength λ1 of the first fundamental wave is projected from the individual output mirror 26e. When the LD light emitter 35 is turned on, a continuous laser beam with wavelength λ2 of the second fundamental wave is projected from the individual output mirror 26e.

In the second embodiment, it is also possible to project laser beams with 5 different wavelengths and 7 different aspects.

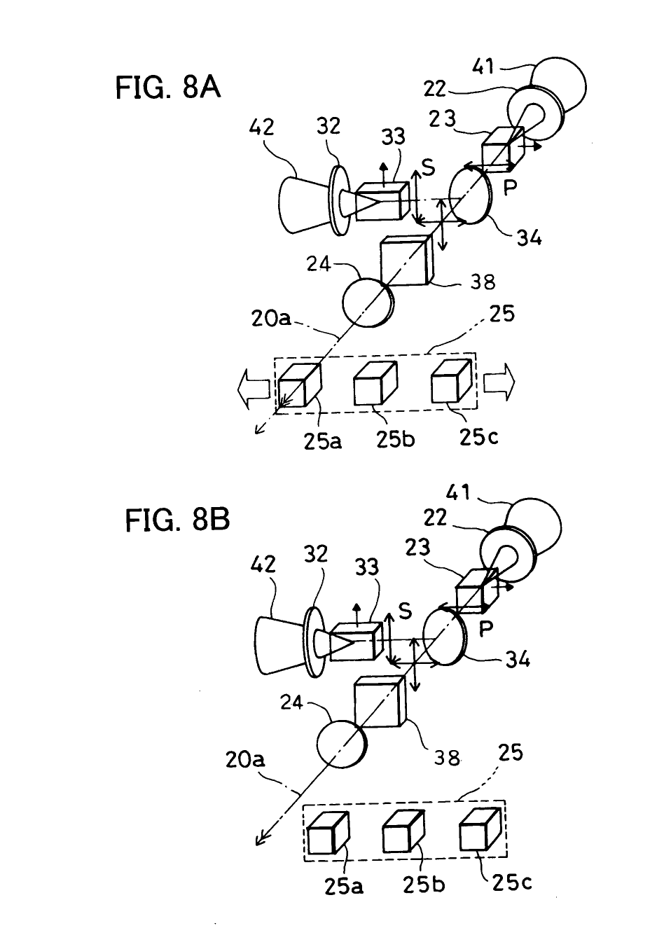

FIG. 8 shows a third embodiment of the invention. In FIG. 8, the same component as shown in FIG. 7 is referred by the same symbol, and detailed description is not given here.

In the third embodiment, the Q-SW element 38 is incorporated in the basic optical system. The Q-SW element 38 is provided between the intermediate mirror 24 and the polarization beam splitter 34 on the commonly used optical axis portion 20a.

When the optical crystal 25a for wavelength conversion is positioned on the commonly used optical axis portion 20a and the LD light emitters 27 and 35 are turned on at the same time, a pulsed laser beam of SFM is projected. When the optical crystal 25b for wavelength conversion is positioned on the commonly used optical axis portion 20a, and only the LD light emitter 27 is turned on, a pulsed laser beam converted to SHG1 is projected. When the optical crystal 25c for wavelength conversion is positioned on the commonly used optical axis portion 20a and only the LD light emitter 35 is turned on, a pulsed laser beam converted to SHG2 is projected. When the wavelength conversion unit 25 is removed from the commonly used optical axis portion 20a and only the LD light emitter 27 is turned on, a pulsed laser beam with wavelength λ1 of the first fundamental wave is projected. When only the LD light emitter 35 is turned on, a pulsed laser beam with wavelength λ2 of the second fundamental wave is projected.

The Q-SW element 38 may be removably mounted on the commonly used optical axis portion 20a. When the Q-SW element 38 is removably mounted, laser beams with 5 different wavelengths and 10 different aspects can be projected.

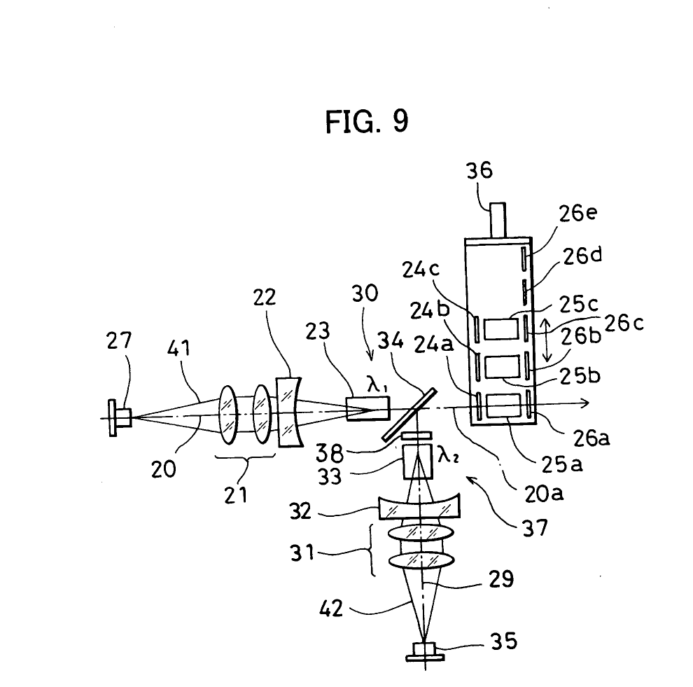

FIG. 9 to FIG. 14 each represents a fourth embodiment of the present invention. In the figures, the same component as shown in FIG. 7 is referred by the same symbol, and detailed description is not given here.

Similarly to the third embodiment, the Q-SW element 38 is incorporated in the basic optical system in the fourth embodiment. The Q-SW element 38 is provided between the second solid-state laser medium 33 and the polarization beam splitter 34 on the second optical axis 29.

The intermediate mirror 24 comprises individual intermediate mirrors 24a, 24b, and 24c. The wavelength conversion unit 25 comprises optical crystals 25a, 25b and 25c for wavelength conversion. The output mirror 26 comprises individual output mirrors 26a, 26b, 26c, 26d and 26e. The individual intermediate mirror 24a and the individual output mirror 26a are provided with the optical crystal 25a for wavelength conversion interposed between the individual intermediate mirror 24a and the individual output mirror 26a. The individual intermediate mirror 24b and the individual output mirror 26b are provided with the optical crystal 25b interposed between the individual intermediate mirror 24b and the individual output mirror 26b. The individual intermediate mirror 24c and the individual output mirror 26c are provided with the optical crystal 25c for wavelength conversion interposed between the individual intermediate mirror 24c and the individual output mirror 26c.

The individual intermediate mirrors 24a, 24b and 24c and the optical crystals 25a, 25b and 25c and the individual output mirrors 26a, 26b, 26c, 26d and 26e are integrally arranged so as to be selectively positioned on the commonly used optical axis portion 20a by the wavelength switching means 36.

The individual intermediate mirror 24a is highly transmissive to the excitation light (wavelength λ), the first fundamental wave (wavelength λ1) and to the second fundamental wave (wavelength λ2), while the individual intermediate mirror 24a is highly reflective to the wavelength conversion light (wavelength λ3) (SFM or DFM). The individual output mirror 26a is highly reflective to the excitation light (wavelength λ), the first fundamental wave (λ1) and to the second fundamental wave (λ2), while the individual output mirror 26a is highly transmissive to the wavelength conversion light (wavelength λ3) (SFM or DFM).

The individual intermediate mirror 24b is highly transmissive to the excitation light (wavelength λ) and to the first fundamental wave (wavelength λ1), while the individual intermediate mirror 24b is highly reflective to the wavelength conversion light (wavelength λ3) (SHG1 (λ1/2)). The individual output mirror 26b is highly reflective to the excitation light (wavelength λ) and to the first fundamental wave (wavelength λ1), while the individual output mirror 26b is highly transmissive to the wavelength conversion light (wavelength λ3) (SHG1 (λ1/2)).

The individual intermediate mirror 24c is highly transmissive to the excitation light (wavelength λ) and to the second fundamental wave (wavelength λ2), while the individual intermediate mirror 24c is highly reflective to the wavelength conversion light (wavelength λ3) (SHG2 (λ2/2)). The individual output mirror 26c is highly reflective to the excitation light (wavelength λ) and to the second fundamental wave (wavelength λ2), while the individual output mirror 26c is highly transmissive to the wavelength conversion light (wavelength λ3) (SHG2 (λ2/2)).

The individual output mirror 26d is highly reflective to the excitation light (wavelength λ), while the individual output mirror 26d is highly transmissive to the first fundamental wave (wavelength λ1). The individual output mirror 26e is highly reflective to the excitation light (wavelength λ), while the individual output mirror 26e is highly transmissive to the second fundamental wave (wavelength λ2).

The individual intermediate mirrors 24a, 24b and 24c may be highly transmissive to the excitation light (wavelength λ), to the first fundamental wave (wavelength λ1), and to the second fundamental wave (wavelength λ2), while the individual intermediate mirrors 24a, 24b and 24c may be highly reflective to the wavelength conversion light (wavelength λ3) (SFM or DFM, or SHG1 (λ1/2) or SHG2 (λ2/2)). The individual output mirrors 26a, 26b and 26c may be highly reflective to the excitation light (wavelength λ), to the first fundamental wave (wavelength λ1), and to the second fundamental wave (wavelength λ2), while the individual output mirrors 26a, 26b and 26c may be highly transmissive to the wavelength conversion light (wavelength λ3) (SFM or DFM, or SHG1 (λ1/2), or SHG2 (λ2/2)). In such case, the individual intermediate mirrors with the same performance characteristics may be used, and the individual output mirrors with the same performance characteristics may be used. In case the individual intermediate mirrors with the same performance characteristics are used, the intermediate mirror 24 may be separated from the wavelength switching means 36 and may be fixed on the commonly used optical axis portion 20a.

As the individual intermediate mirrors 24a, 24b and 24c, dielectric reflection films formed on end surfaces on incident sides of the optical crystals 25a, 25b and 25c for wavelength conversion may be used. Similarly, as the individual output mirrors 26a, 26b and 26c, dielectric reflection films formed on end surfaces on exit sides of the optical crystals 25a, 25b and 25c for wavelength conversion may be used.

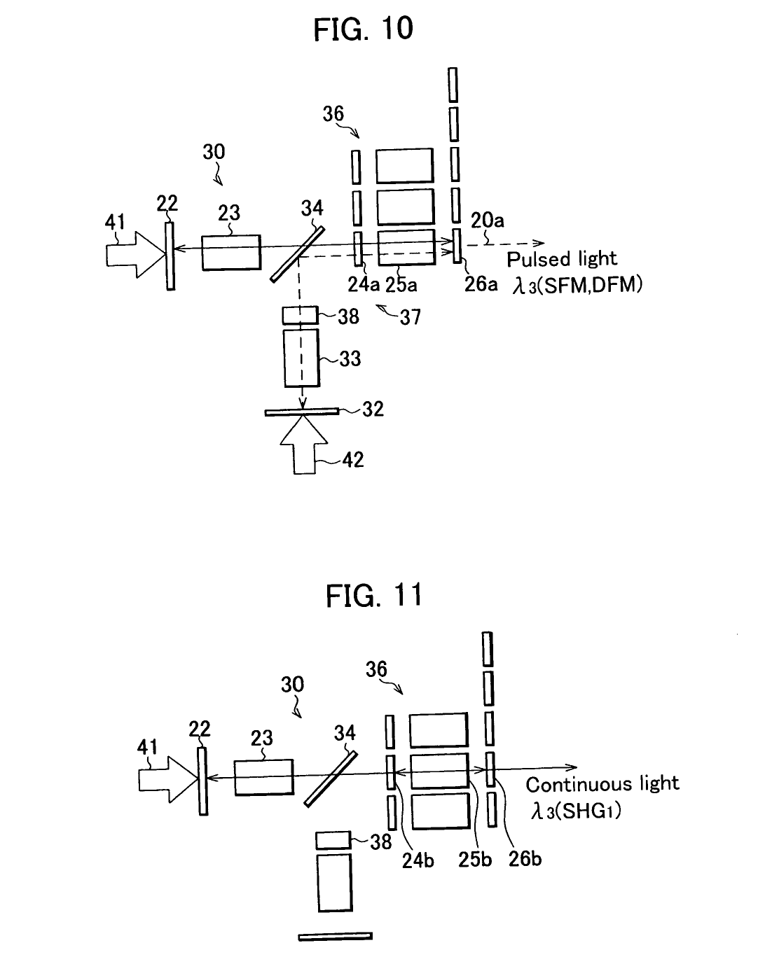

Referring to FIG. 10 to FIG. 14, description will be given on operation of the fourth embodiment.

FIG. 10 shows a case where a pulsed laser beam with wavelength λ3 (SFM or DFM) of the wavelength conversion light is projected. The individual intermediate mirror 24a, the optical crystal 25a for wavelength conversion, and the individual output mirror 26a are positioned on the commonly used optical axis portion 20a by the wavelength switching means 36.

The LD light emitters 27 and 35 are turned on. The laser beam 41 is allowed to enter the first resonator 30, and the laser beam 42 is allowed to enter the second resonator 37.

At the first resonator 30, the first fundamental wave with wavelength λ1 is oscillated. At the second resonator 37, the second fundamental wave with wavelength λ2 is oscillated by pulse oscillation because the Q-SW element 38 is provided. When the first fundamental wave and the second fundamental wave enter the optical crystal 25a for wavelength conversion, wavelengths are converted, and a wavelength conversion light with wavelength λ3 (SFM or DFM) is projected as a pulsed light.

FIG. 11 shows a case where the wavelength of the first fundamental wave is converted and a continuous wavelength conversion light with wavelength λ3 (SHG1 (λ1/2)) is projected.

The individual intermediate mirror 24b, the optical crystal 25b for wavelength conversion, and the individual output mirror 26b are positioned on the commonly used optical axis portion 20a by the wavelength switching means 36. Only the LD light emitter 27 is turned on, and the laser beam 41 enters the first resonator 30.

By the first solid-state laser medium 23, the first fundamental wave is oscillated. The first fundamental wave is converted to a wavelength conversion light with wavelength λ3 (SHG1 (λ1/2)) by the optical crystal 25b for wavelength conversion, and a continuous wavelength conversion light (λ3) is projected from the individual output mirror 26b.

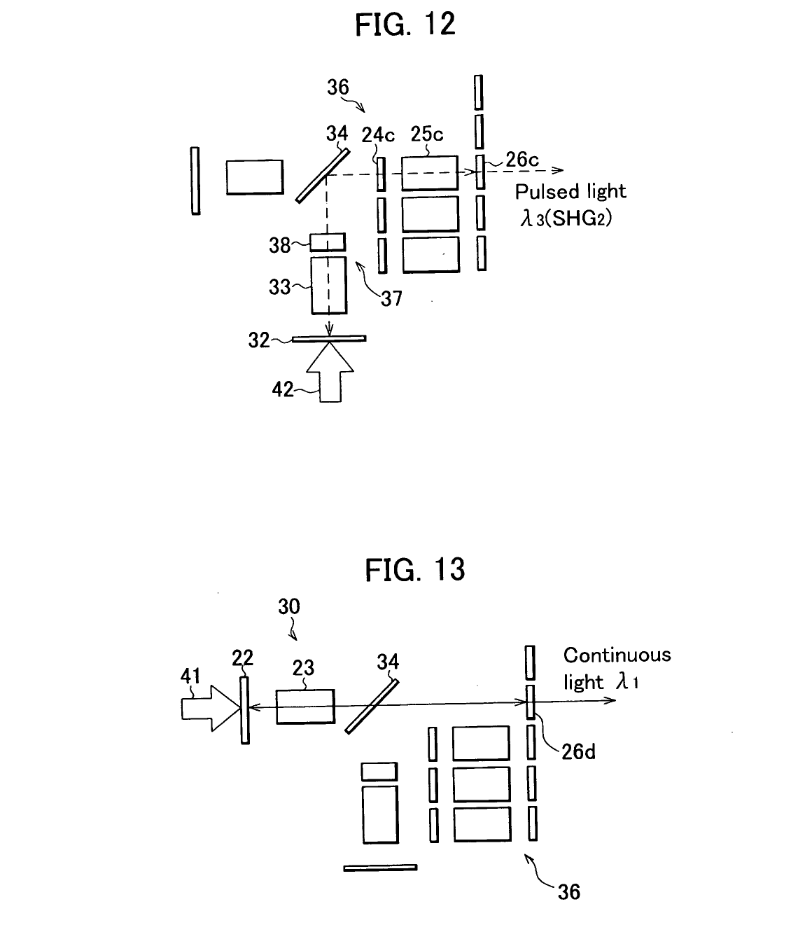

FIG. 12 shows a case where the wavelength of the second fundamental wave is converted, and a pulsed wavelength conversion light with wavelength λ3 (SHG2 (λ2/2)) is projected.

By the wavelength switching means 36, the individual intermediate mirror 24c, the optical crystal 25c for wavelength conversion, and the individual output mirror 26c are disposed on the commonly used optical axis portion 20a. Only the LD light emitter 35 is turned on, and the laser beam 42 enters the second resonator 37.

By the second solid-state laser medium 33, the second fundamental wave is oscillated. The second fundamental wave is converted to a wavelength conversion light with wavelength λ3 (SHG2 (λ2/2)) by the optical crystal 25c for wavelength conversion. Further, pulse oscillation is performed by the Q-SW element 38, and a pulsed wavelength conversion light (λ3) is projected from the individual output mirror 26c.

FIG. 13 represents a case where a continuous first fundamental wave with wavelength λ1 is projected.

By the wavelength switching means 36, the individual output mirror 26d is disposed on the commonly used optical axis portion 20a. Only the LD light emitter 27 is turned on, and the laser beam 41 enters the first resonator 30. By the first solid-state laser medium 23, the first fundamental wave is oscillated, and a continuous light of the first fundamental wave is projected from the individual output mirror 26d.

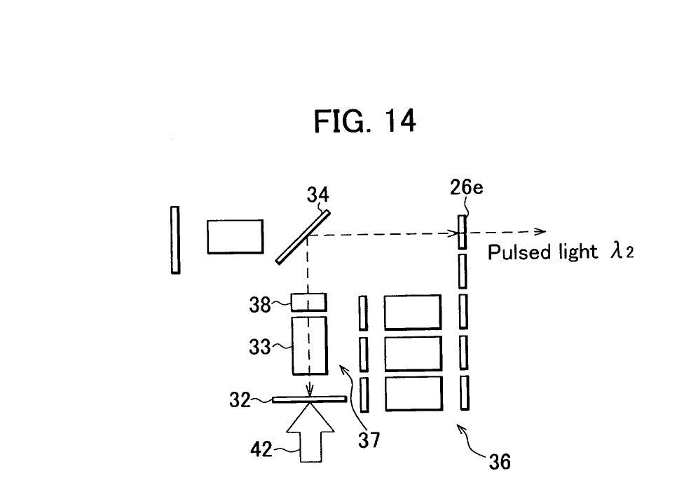

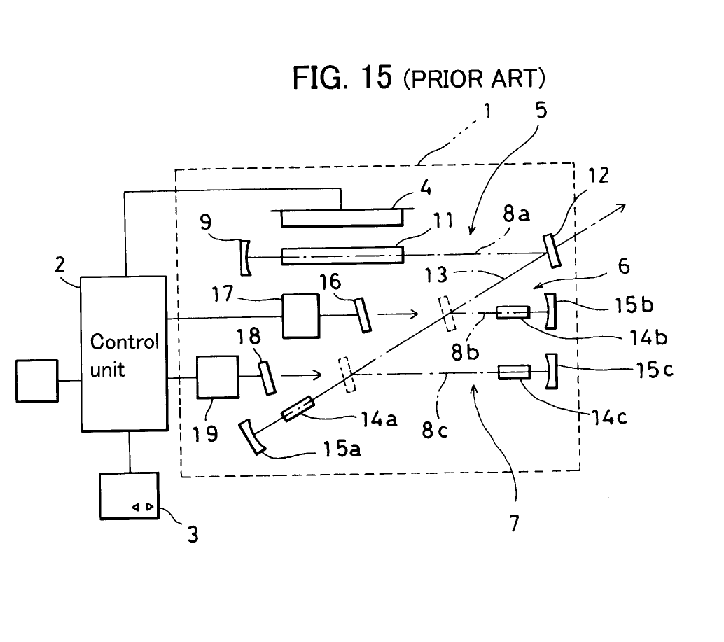

FIG. 14 shows a case where a pulsed light of the second fundamental wave with wavelength λ2 is projected.

By the wavelength switching means 36, the individual output mirror 26e is disposed on the commonly used optical axis portion 20a. Only the LD light emitter 35 is turned on, and the laser beam 42 enters the second resonator 37. By the second solid-state laser medium 33, the second fundamental wave is oscillated. Further, pulse oscillation is performed by the Q-SW element 38, and a pulsed light of the second fundamental wave is projected from the individual output mirror 26e.

In the fourth embodiment, it is possible to project laser beams with 5 different wavelengths. In the above, the Q-SW element 38 is arranged on the second optical axis 29, while the Q-SW element 38 may be arranged on the first optical axis 20, or the Q-SW element 38 may be removably arranged on the second optical axis 29 or on the first optical axis 20. By removably arranging the Q-SW element 38, a pulsed laser beam or a continuous laser beam can be properly selected.

In the above first embodiment, it may be designed in such manner that the optical crystals 25a, 25b and 25c for wavelength conversion are mounted on a rotating disk, and the optical crystals 25a, 25b and 25c for wavelength conversion are switched over by rotation. Also, it may be designed in such manner that the output mirrors 26a, 26b, 26c, 26d and 26e are provided on a sliding disk, which moves in a direction crossing perpendicularly to the commonly used optical axis portion 20a, and by sliding the sliding plate, the output mirrors 26a, 26b, 26c, 26d and 26e may be switched over. In this case, a through-hole where the laser beam passes through is further formed on the rotating disk.

Further, in the second embodiment, it may be designed in such manner that a combination of the individual intermediate mirrors 24a, 24b and 24c, the optical crystals 25a, 25b and 25c for wavelength conversion, the output mirrors 26a, 26b, 26c, 26d and 26e, and the Q-SW element 38 may be mounted on a rotating disk, and the output mirrors 26a, 26b, 26c, 26d and 26e, etc. may be switched over by the rotation of the rotating disk.

Also, in the fourth embodiment, it may be designed in such manner that a combination of the individual intermediate mirrors 24a, 24b and 24c, the optical crystals 25a, 25b and 25c for wavelength conversion, and the output mirrors 26a, 26b, 26c, 26d and 26e is mounted on a rotating disk, and the individual intermediate mirrors 24a, 24b and 24c, the optical crystals 25a, 25b and 25c for wavelength conversion, and the output mirrors 26a, 26b, 26c, 26d and 26e may be switched over by the rotation of the rotating disk.

In the fourth embodiment, the Q-SW element 38 is provided alone on one of the first resonator 30 or the second resonator 37. Thus, the Q-SW element 38 should match only one of the laser beams, and this facilitates the simplification of the arrangement and the proper adjustment of the optical axis and so on.

What is claimed is:

1. A solid-state laser device, comprising a first optical axis and a second optical axis having a commonly used optical axis portion and separated by an optical axis separating means, a first resonator composed on said first optical axis, a second resonator composed on said second optical axis, a first light emitter for allowing an excitation light to enter said first resonator, a second light emitter for allowing an excitation light to enter said second resonator, a wavelength conversion unit provided on said commonly used optical axis portion, and an output mirror provided on an exit side of said wavelength conversion unit, wherein said wavelength conversion unit comprises two or more optical crystals for wavelength conversion, said output mirror has two or more individual output mirrors, and a wavelength of a laser beam to be projected is determined by selection of turning-on or turning-off of said first light emitter and said second light emitter, and also by selection of said optical crystals for wavelength conversion and said individual output mirrors depending on turning-on and turning-off of said first light emitter and said second light emitter.

2. A solid-state laser device according to claim 1, wherein said two or more optical crystals for wavelength conversion are selectively positioned on said commonly used optical axis portion by a wavelength switching means, and said two or more individual output mirrors are selectively positioned on said commonly used optical axis portion by an output mirror switching means.

3. A solid-state laser device according to claim 1, wherein said two or more individual output mirrors and said two or more optical crystals for wavelength conversion to match types of the projected laser beams are provided, wherein said two or more optical crystals for wavelength conversion are provided integrally with corresponding individual output mirrors, and said individual output mirrors and said optical crystals for wavelength conversion are selectively positioned on said commonly used optical axis portion by a wavelength switching means.

4. A solid-state laser device according to claim 2, wherein said wavelength switching means selectively positions said optical crystals for wavelength conversion by sliding from a direction crossing with respect to said commonly used optical axis portion.

5. A solid-state laser device according to claim 2, wherein said output mirror switching means selectively positions said individual output mirrors provided on a rotating disk by rotating said rotating disk.

6. A solid-state laser device according to claim 3, wherein said wavelength switching means selectively positions said individual output mirror and said optical crystals for wavelength conversion by sliding from a direction crossing with respect to said commonly used optical axis.

7. A solid-state laser device according to claim 3, wherein said output mirror switching means selectively positions said optical crystals for wavelength conversion and said individual output mirrors provided on a rotating disk by rotating said rotating disk.

8. A solid-state laser device according to claim 1, wherein a Q-SW element is provided on said commonly used optical axis portion.

9. A solid-state laser device according to one of claims 1, 2, 3, 5 or 7, wherein a Q-SW element is integrally provided to match at least one of said individual output mirrors.

10. A solid-state laser device according to claim 1, wherein a Q-SW element is provided on at least on one of said first optical axis and said second optical axis being separated.

11. A solid-state laser device according to one of claims 1, 2, 3, 4, 6 or 7, wherein individual intermediate mirrors being highly reflective to a conversion wavelength are integrally provided on each of incident sides of said optical crystals for wavelength conversion.

12. A solid-state laser device according to claim 1, wherein said first resonator comprises a first solid-state laser medium, said second resonator comprises a second solid-state laser medium, wherein a direction of a crystal axis of said first solid-state laser medium and a direction of a crystal axis of said second solid-state laser medium are adjusted in such manner that oscillated fundamental waves are linearly polarized lights and have different directions of polarization.
